(19) United States
(12) Patent Application Publication
(10) Pub. No.: US 2003/0185932 A1
(43) Pub. Date: Oct. 2, 2003

(54) Injection screw drive of a plastic injection molding machine

(76) Inventors: Franz Chromy, Mollis (CH); Robert Weinmann, Weesen (CH); Erich Knobel, Horgen (CH)

Correspondence Address: FINNEGAN, HENDERSON, FARABOW, GARRETT & DUNNER, LLP, 1300 I STREET, NW, WASHINGTON, DC, 20005, US

(21) Appl. No.: 10/296,289

(22) PCT Filed: May 23, 2001
(86) PCT No.: PCT/CH01/00320

(30) Foreign Application Priority Data
May 24, 2000 (CH) 1036/00
Sep. 28, 2000 (CH) 1899/00
Nov. 14, 2000 (CH) 2211/00

(51) Int. Cl. B29C 45/48

(52) U.S. Cl. 425/587

(57) ABSTRACT

The invention relates to an injection screw drive for a plastic injection molding machine comprising axes (A1, A2) respectively provided for the rotative and for the axial motion of the injection screw (4). According to the invention, the injection screw drive has at least one double rack rail overdrive for effecting the axial motion. The injection worm drive is configured as a gear combination having at least two drive motors (18, 44) and an output axle. The gear combination has, as a core, a gear block with a gear casing (42), to which at least two reducing gears are connected that effect the rotative and the axial motion of the injection screw (4). This enables the entire machine to be provided with a short and compact structure insofar as this concerns the injection aggregate. According to a second embodiment, both drives have separate housings. The entire injection unit rests, in a known manner, on the machine stand (33) via guide rails (32) such that it can be displaced.

### TECHNICAL AREA

The invention relates to a drive of the injection screw of a plastic injection molding machine having at least one electric motor for the rotative and for the axial movement of the injection screw.

### STATE OF THE ART

In injection molding, a distinction is made between several successive sequences. Plastic is fed into the injection cylinder through a feed hopper. The rotating injection screw collects the raw material through the screw flights and moves it forward in the heated injection cylinder. The rotative movement of the screw flights continues to feed the plastic towards the tip of the injection screw. The raw material is melted primarily due to the geometry of the screw and/or the appropriate frictional heat and arrives as a melt in a collection space directly in front of the nozzle. The applicable approximate value is that the largest part of the fusion heat is generated by mechanical work between the injection screw and the travel of the cylinder, and the rest by the jacket heating. During continued rotative movement of the screw, the melt will collect in the collection space and move the injection screw backward in its axial direction due to the increase of volume in the collection space. If the quantity of liquid plastic required for a shot is available in the collection space, the rotary actuator of the screw is stopped. The forward movement closes the non-return valve attached at the tip of the screw. The injection screw then assumes the function of an injection piston. To inject the plastics mass into the form, a hydraulic, also called a piston drive in the following, is activated in the classical state of the art. The piston drive pushes the entire screw forward as a pure axial movement. The injection screw, now acting as a piston, injects the melt through the nozzle into the cavities of the form. The injection itself takes place in two phases: The first phase is the actual filling. The required pressure may increase up to a range of 2,000 bar around the end of the filling phase. The filling is followed by the phase of the holding pressure, whereby the approximate final pressure of the filling phase is maintained. To ensure the aforementioned sequences during injection molding, two completely different types of drives are required:

the axial drive of the plasticizing screw in the sense of a piston

the rotative drive of the plasticizing screw in the sense of a conveyer screw.

In the past, it was obvious to design the piston drive hydraulically and the rotative drive electromotively. Optimal use can be made of the specific advantages of the two different drive forms. With hydraulic cylinders, the largest possible linear displacement force without forming is used for a linear movement. With electromotive drives, however, the generated rotative power is available as such with appropriate gear reduction.

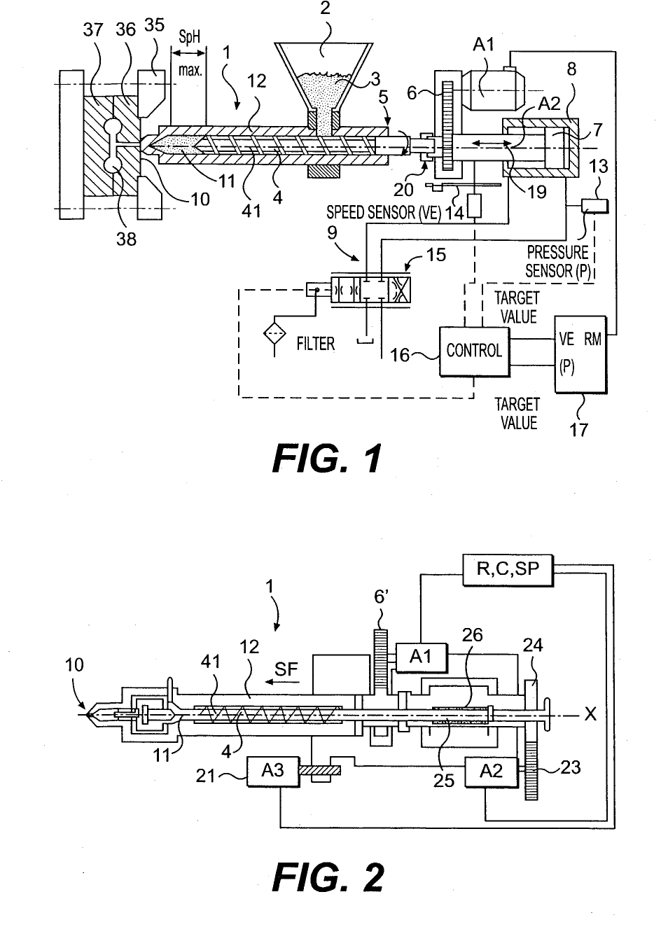

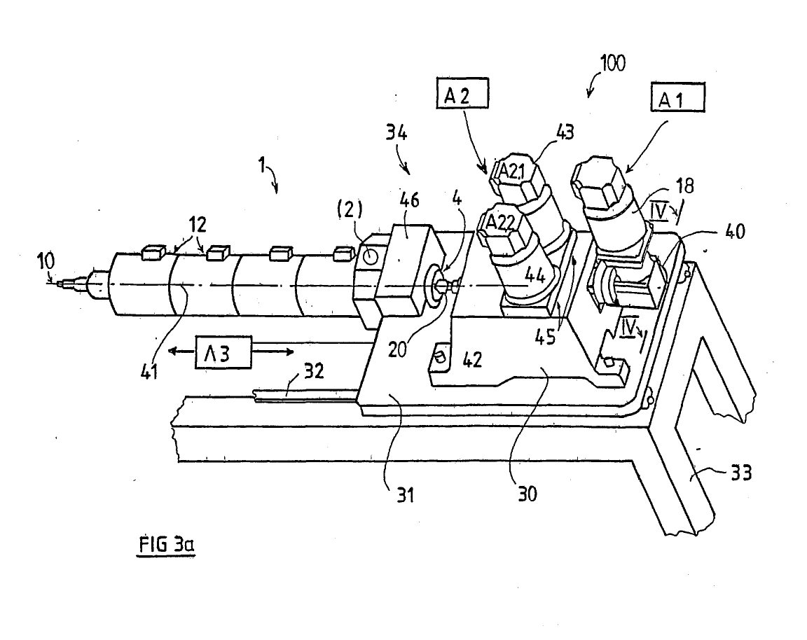

The FIGS. 1 and 2 show two typical solutions of the state of the art: FIG. 1 shows a combined hydraulic/electrical solution, and FIG. 2 shows a so-called electrical solution. In FIG. 1, the axial movement is operated by a hydraulic piston and the rotation by the rotational axis of a motor.

EP 451 294 uses a different method. For the injection movement of the screw, a pure crank mechanism with a crank or a toggle lever system between a stationary plate as well as a plate that can be moved toward and away from said stationary plate is proposed. The one crank is provided to translate a forward- and backward rotation of the drive axle into a to- and from movement of the injection conveyer screw. The drive and/or overdrive for the axial movement of the injection screw is used as impact force between the stationary plate and the conveyer screw. The applicant is not aware whether a solution in accordance with EP 451 294 (corresponds to DE 690 18 063) has been realized in practice. The specification refers exclusively to the specific use of a crank mechanism for the injection conveyer screw. In doing so, it was recognized that it could be problematic if a crank mechanism is operated near the zero point. The proximity of the zero- or dead point should be avoided in the proposed application with injection screws.

As another option, EP 427 438 shows the combination of a toggle lever system and a toothed rack drive for the forming movement. An appropriate use for the axial drive of the injection screw has not become known. What is interesting, however, is the proposal of the actual toothed rack gear with flange-mounted drive motor. As in the technical jargon, in the following a single motor drive is understood as a single “axle” in the sense of the motor axle. Therefore, EP 427 438 proposes a toothed rack drive for the one axle of the forming movement. In practice, such toothed rack drives have found wide acceptance for the drive of the movable form.

### DETAILED REPORT OF THE INVENTION

The object to be attained by the invention was the development of an advantageous drive concept for the axial and the rotative movement of the injection screw. Another object was to combine the suitable components for an economical production to create a structurally optimal drive concept for the two movement types of the injection screw.

In accordance with the invention, the drive of the injection screw is characterized in that it has a rack rail overdrive with at least one double rack rail for the axial movement of the injection screw, and the rotative and the axial movement can be combined in one drive unit.

The new solution primarily proposes two things:

the use of at least one double rack rail, as well as

the formation of a drive unit.

As it will be explained in greater detail in the following, the new solution allows for several embodiments. They all have in common independent electrical motors for the rotative and the axial movement. The examinations have shown that a gear combination with only one simple rack rail drive in accordance with the state of the art is certainly possible. However, in the realization, there are enormous cost problems with only one rack rail because of the physical size of the individual components and the control of the resulting forces. Surprisingly, the double rack rail drive has proven to be particularly advantageous. At least for the essential part, the lateral forces balance themselves. The core is a drive unit with two completely separated and independently working drive motors for the two types of movement of the injection screw, with only one axle on the drive side of the drive unit.

Reference is made to the claims 2 to 26 with respect to the various developments, especially also for particularly advantages embodiments.

An important special feature of a first embodiment is a compact assembly and/or drive unit, where two double rack rails parallel to the axle of the injection screw ensure the axial drive. Precise clarifications have shown that an economically optimal drive unit can be obtained with this specific embodiment. This means a relatively economic production cost and an ideal function for an entire drive concept. The result is a compact assembly comprised of a multiple of subassemblies. Preferably, helical gearings are used. Advantageously, the helical gearings of both sides oppose one each rack rail to compensate the forces from the helical gearing. It is furthermore proposed to design the helical gearing of both double rack diametrically opposed to compensate the momentum from the helical gearing of the two double rack rails. The proposed solution leads to an economical construction especially in that it permits the use of relatively small pinions, which are much less costly in the popular size. The pinions are arranged to be adjustable in the direction of their axis of rotation for adjusting the gear mesh and the complete force compensation, if possible. In cases where only one pinion is driven directly, the adjustability effects that the remaining pinions can be adjusted for an optimal gear mesh.

The second embodiment also has a compact assembly, with the rack rail drive and the rotative drive being arranged in a guide tube.

Owing to this advantageous embodiment, the rack rail overdrive has two rack rails, each spaced and parallel to the axis of rotation of the injection screw and the gear-tooth profile preferably directed outward, and the axis of action of the rack rail overdrive at least approximately coincides with the rotary actuator axle for the rotative movement of the injection screw. The second method of embodiment is characterized in that the gearing for the rotative movement and the gearing for the axial movement are integrated and combined in a common assembly. As will be shown later, the second solution shows an unexpected compactness, especially because two drive axles are assigned to a single gearing, which is not common, at least not in conventional industrial practice. Rather, it is expected of a gearing that one or a plurality of outputs are provided by a motor drive and/or an axle. The drive of the injection screw requires the two completely different types of drives (axial and rotative). The surprising positive effects will now be explained by means of especially advantageous embodiments. The rack rail is arranged in distance and parallel to an imagined extension of the axis of rotation of the injection screw, with preferably two rack rails being arranged symmetrically in distance and parallel to the axis of rotation of the injection screw and with the gear-tooth profile directed outward.

Advantageously, the rotation- and displacement mechanism is designed as a compact assembly and guided in a guide tube that is in alignment with the axis of the injection screw. In the first and second embodiment, the rack rails are mounted on the output side with a secure connection to the housing of the screw coupling component. The screw coupling component itself has on the drive side an axial and a radial bearing, with the housing being mounted in the guide tube through one, two or a plurality of guide bands. The rotative drive is effected through a splined hub as well as a splined shaft, which, on the one hand, are free to slide into one another, while on the other hand being connected with motor gearing. On the drive side, the splined shaft is mounted in the gearing and slideably guided in a splined hub for the required stroke length. On the other side, the splined hub is securely connected to the screw coupling by a sleeve. The splined hub and the sleeve run essentially over the useable length of the rack rails. The splined shaft itself is in alignment with the axis of the screw shaft. The sleeve and the rail racks are arranged coaxially thereto. The basic function of the injection screw requires a longitudinal displacement, i.e., a stroke determined by the size of the part to be injection-molded; in the case of a larger machine, this would be 20 centimeters, for example. By inserting the two drive mechanisms, i.e., the rack rail as well as the splined shaft, into one another, only a minimum of assembly length is required. The second solution method involves an especially short assembly. The rack rails are guided with a guide band in the guide tube through a blind flange on the end side facing away from the injection screw. With the aforementioned embodiments, it is possible to slide the combined gearing extremely compact into a piece of tube where it can be centrally lubricated and easily sealed on all sides against the leaking of lubricants, and where it yields, in view of a clean room technology, an ideal condition. Preferably, the two rack rails are developed a double rack rails with one each independent drive pinion, gearing as well as drive motor, especially one or two AC-servo motors. Means of computation and/or control/regulation are assigned to the drive motors through appropriate performance electronics to completely balance the movement, especially also the drive momentum.

With respect to the injection screw drive, the drive motors are preferably built with the axles projecting upward. In this way, the entire machine can be built short and compact, at least as far as the injection aggregate is concerned. As is generally known, the entire injection unit rests on the machine stand and is displaceable through guide rails. Preferably, an additional drive concept is provided for the displacement movement of the complete aggregate.

### BRIEF DESCRIPTION OF THE INVENTION

The invention is now explained in greater detail by means of a comparison with the state of the art and a few embodiments. Shown are in

FIGS. 1 and 2 two embodiments of the state of the art;

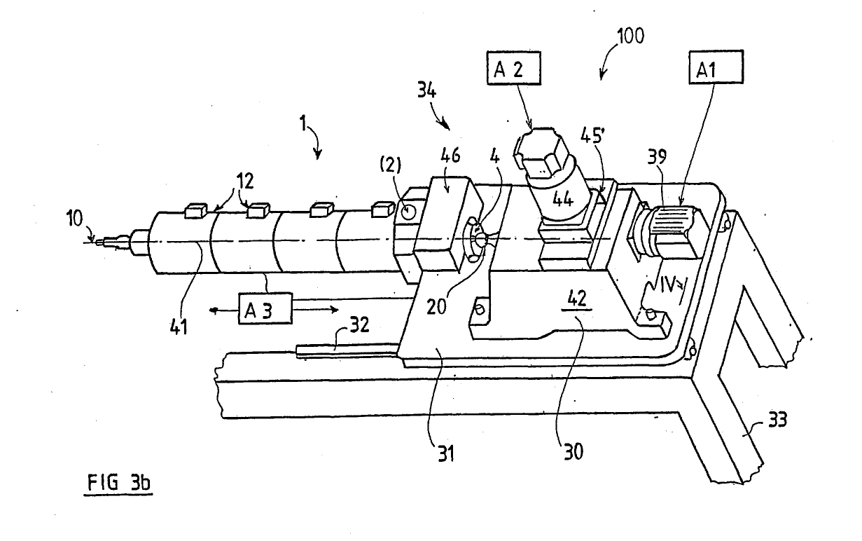

FIGS. 3a and 3b one each perspective view of a double axle drive in accordance with the invention with one and/or two drive motors for the axial movement;

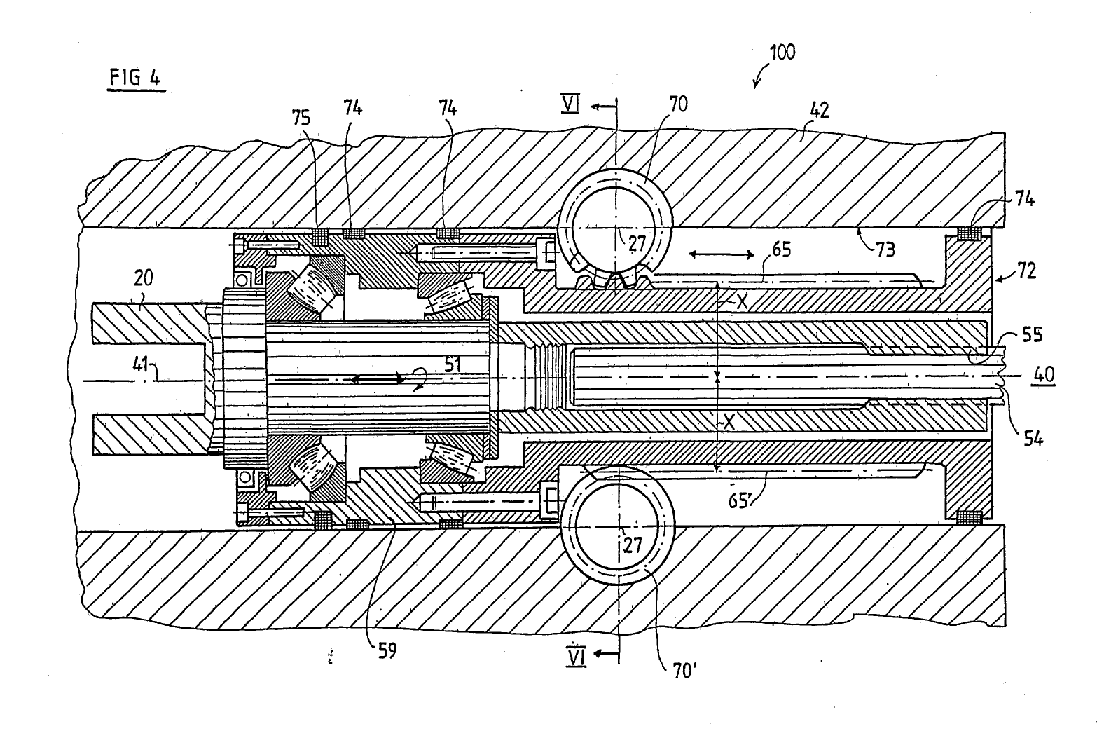

FIG. 4 a longitudinal section IV-IV of FIG. 3a;

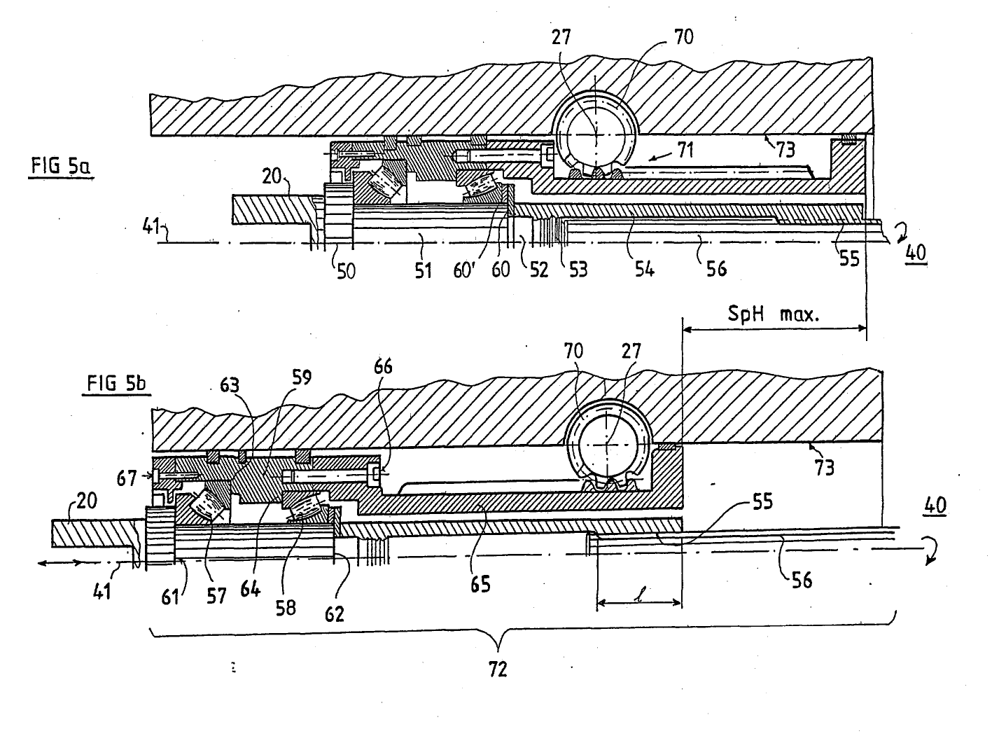

FIGS. 5a and 5b the stroke and/or the axial movement, based on a rack rail overdrive;

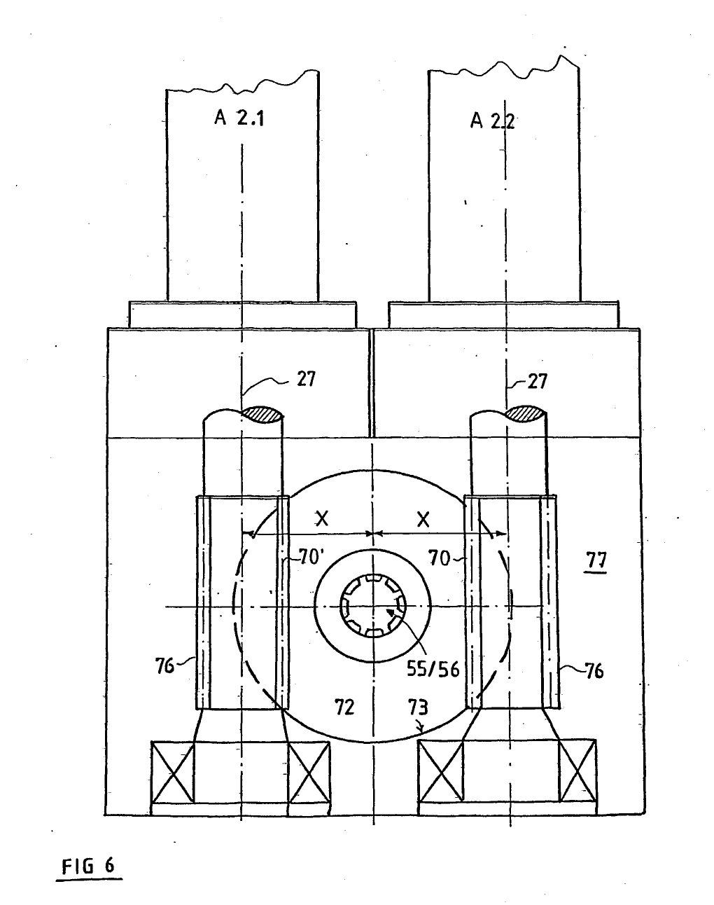

FIG. 6 a section VI-VI of FIG. 4;

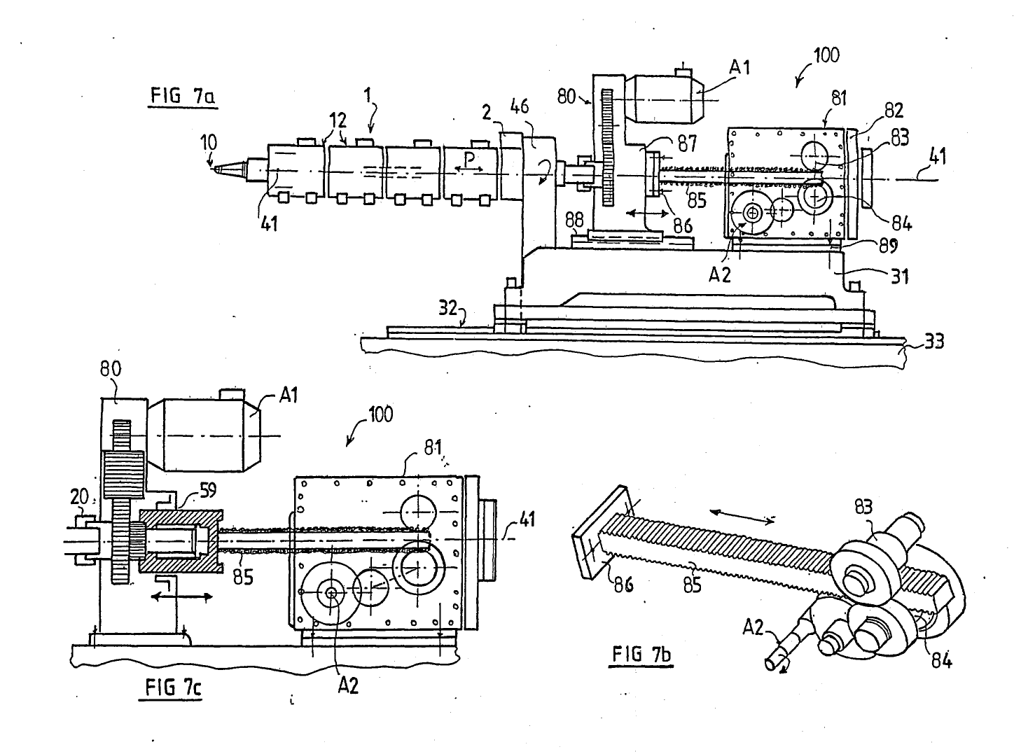

FIG. 7 the injection side of an injection molding machine, in partial section;

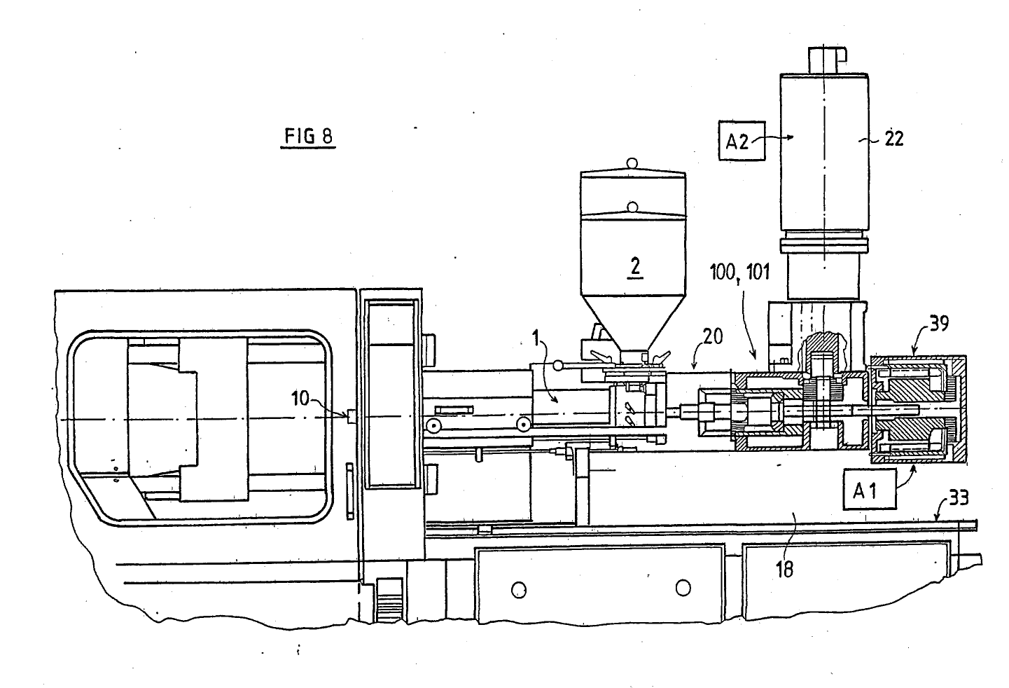

FIG. 8a a section X-X of FIG. 8b and

FIG. 8b a section IX-IX of FIG. 8a of the gear combination;

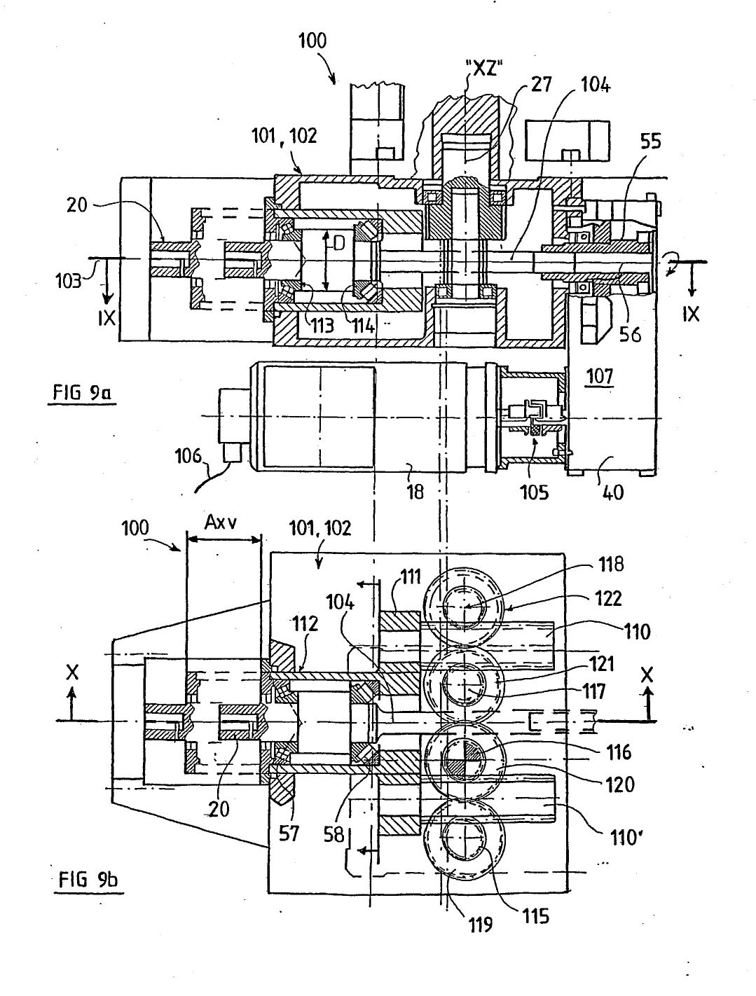

FIG. 9 the gear combination with two independent drive motors;

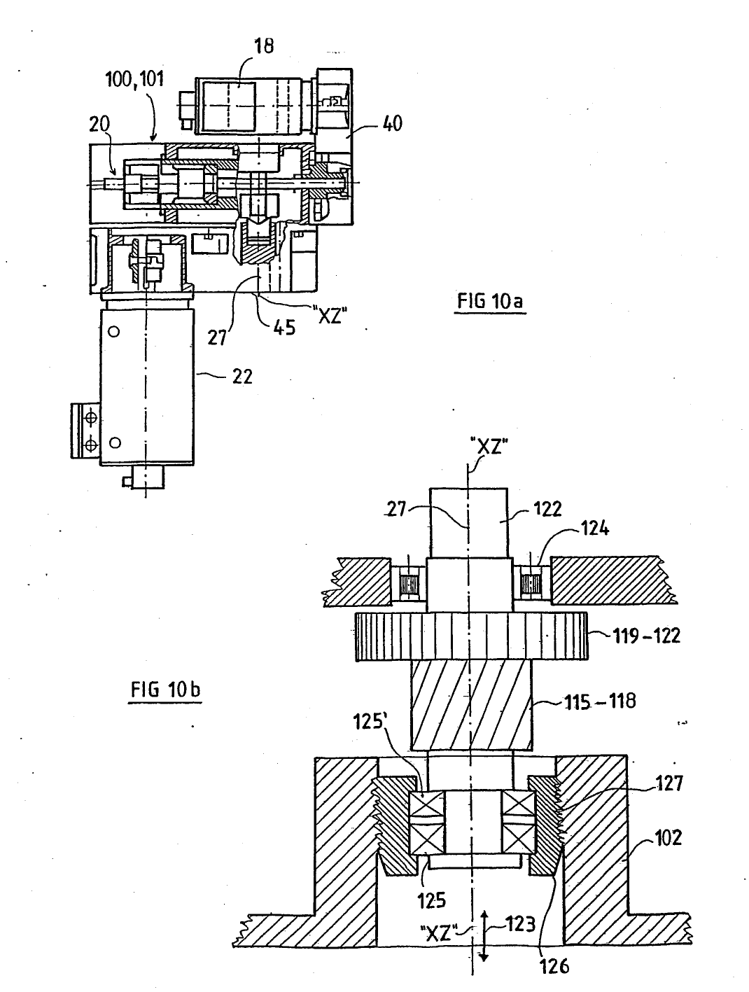

FIG. 10 the adjustability of a pinion in its axial direction for the adjustment.

### WAYS AND IMPLEMENTATION OF THE INVENTION

FIG. 1 shows schematically as state of the art a textbook example for the injection side of an injection molding machine. The core is an injection cylinder 1 into which raw material 3, usually in the form of granulate, is fed through a feed hopper 2. In the injection cylinder 1 is a conveyer screw and/or injection screw 4, which is mounted at the right side in a point of support 5. The rotative movement of the injection screw is generated by the axle A1 through a set of gears 6, and the axial injection movement (axle A2) is generated by a hydraulics piston 7 that can be moved in a hydraulic cylinder 8 by an axial displacement path. The axial displacement path is oriented on the desired shot quantity for the injection molding of a part and/or the corresponding quantity in the case of multiple forms. On the very left, the injection cylinder 1 ends in a nozzle 10, through which the melted plastics mass 11 is injected into the cavities 38 of the two form halves 36, 37. Heating packets 12 enclose the injection cylinder 1. The measuring reference SpH descries the selectable injection stroke, with SptHmax meaning the maximum injection stroke. It is assumed that the technology of the injection process is known. The “periphery” required for hydraulics is only indicated with reference symbol 9. The reference symbol 13 marks a pressure sensor (P) and the reference symbol 14 marks a speed sensor (VE). The piston 7 is controlled by a servo- or proportional valve 15. The required control impulses are given by a control 16 and/or a machine control 17. The rotative movement of the injection screw 4 is actuated by a drive motor 18 (denoted as axle A1). The axial movement is actuated by the hydraulics piston 7 and/or the piston rod 19 (axle A2). The two axles A1 and A2 are completely independent of one another, but share the same output on the coupling piece 20 for the injection screw 4.

The basic structure of the injection cylinder 1 is, in as much as it concerns the range of the conveyer screw, identical for the FIGS. 1 and 2. FIG. 2 shows schematically an example of a purely electrical solution, and in addition, a motor 21 that moves the entire injection aggregate for the delivery and removal of the nozzle 10 to and from the injection mold. The motor 18 (axle A1) drives the gears 6′ for the rotative movement of the conveyer screw and the motor 22 [drives] the gears 23 and 24, for the piston movement and/or the axial movement of the injection screw 4. The transfer of movement can be effected, for example, through a shaft 25 as well as a ball screw 26.

FIGS. 3a and 3b show in perspective view two examples of the new solution. A double axle gearing 30 is mounted on a base plate 31. Through an axle A3, the complete injection aggregate 34 is arranged slideably on rails 32 on the machine stand 33 for the nozzle feed to the form 36, which is arranged on a secured form base plate 35, analogue to FIG. 1. Together with a movable form 37, the form 36 (not shown in FIGS. 3a and 3b) forms the cavities 38 for the plastic mould to be injection-molded. What is strikingly different in FIG. 3a in addition to the double axle gearing 30 are the axles A1 and A2. Two motors A2.1 and A2.2 are provided for the axle A2. A2 corresponds to the drive motor 18 of the FIGS. 1 and 2. The drive motor 18 is flange-mounted on the gear housing 42 through a gearing 40 with an output aligned with the screw axis 41. Two identical drive motors 43 and 44 are flange-mounted as axle A2, also through one ach gearing 45, at the gear housing 42. All three motors 18 as well as 43 and 44 each have a perpendicular motor shaft and therefore allow for a very short construction. The injection cylinder 1 is connected to the base plate 31 through a housing block 46, so that the conveyer screw 4 can be driven by the double axle gearing axially as well as rotatively through the coupling piece 20, which is freely accessible from the outside. The action- and/or reaction forces are closed primarily through the base plate 31. FIG. 3b shows only one drive motor 44 with a gearing 45′ for the drive of two rack rails 65. The gear 45′ correspondingly has two outputs.

In variation to FIG. 3a, the axle A1 in FIG. 3b has a hollow motor 39 that is flange-mounted directly at the gear housing 42.

FIG. 4 as well as FIGS. 5a and 5b show an example for a double axle gearing in section IV-IV of FIG. 3a. FIGS. 4 and 5a show the backward position of the injection screw in an extreme position, for example as service position or off-line position, or for the maximum possible screw backwards position and/or for the theoretically largest possible injection molding piece, with maximum injection of the plastics quantity 11 corresponding to Sp H.max (FIG. 1). FIG. 5b shows the other extreme position at the end of each injection process and/or in the phase of the holding pressure. The screw coupling 20 is securely screwed with a sleeve 54 through a flange 50 and a stub shaft 51, a supporting sleeve 52 as well as a screw connection 53, and connected at the opposite end through a splined hub 55 to a splined shaft 56 and the gearing 40 for the rotative movement. The moment of torsion to the conveyer screw and/or injection screw 4 is therefore transmitted directly from the splined hub 55 to the coupling piece 20 through the sleeve 54, regardless of the position of the splined hub 55 (with length 1) relative to the splined shaft, as is shown in FIGS. 5a and 5b. The stub shaft 51 is supported in a bearing bushing 59 through two strong radial/axial roller bearings 57 and 58. The inner rings of the two bearings 57, 58 are held through supporting rings 60, 60′ between the shoulders 61 and 62 with the clamping force generated by the sleeve 54 and the thread 53. The outer rings of the two bearings 57/58 are held in the borings of the bearing bushing 59 with corresponding shoulders 63, 64 in such a way that the axial flow of power is directed from the injection screw 4 directly through the stronger bearing 57 and the bearing bushing 59 to the rack rail 65. The rack rail 65 is connected rigidly to the bearing bushing 59 through locking screws 66, and held at the opposite end by a fixation ring 67 and the inner bearing ring of the bearing 57. The axial movement of the conveyer screw and/or the corresponding action- and reaction forces are, proceeding from the two motors 43, 44, the gearing 45 as well as two pinion gears 70, 70′, transmitted through the two rack rails 65, 65′, the bearing bushing 59, the bearings 57 as well as the coupling piece 20. The coupling piece 20 and the stub shaft 51 are therefore driven by the two axles A1 and A2 (and/or A2.1/A2.2). The two main elements of transmission, spline shaft overdrive 72 as well as rack rail overdrive 71, allow an independent control of the two types of movement (axial, rotative) and are combined in a gear block 77 that is integrated into a cylindrical boring 73. To achieve a complete power symmetry, the axle A2 is developed as a double axle, with two mutually adjustable motors, two gearings, two pinion gears as well as two rack rails. As stated by X-X, the rack rails are arranged parallel and in the same distance to the screw axis 41. The term double axle gearing relates to the respective axles A1 and A2 for the rotative as well as the axial movements of the injection screw.

FIG. 6 shows schematically a cross-section through the double axle gearing. FIG. 6 clearly shows the symmetry of all drives and/or the transmissions of power. The complete gear block 77 is guided through guide bands 74 in the boring 73 (FIG. 4) and has a stripper 75 to prevent any escape of lubricating oil from the inside of the gearing. According to FIG. 6, the axles 76 of the two pinion gears are perpendicular, which is advantageous with respect to the use of space. The two axles should be parallel to one another, but can also be slanted or horizontal. If there is sufficient space in the back in the direction of the screw axle 41, it is also possible to arrange a motor 18 with horizontal axis.

FIGS. 7, 8a, 8b as well as 9 and 10 show another example of an especially advantageous embodiment of the new solution. The components, which are essentially the same, have the same reference symbols as in the previously shown solutions. The solution according to FIG. 7 shows analogously to FIGS. 3a to 6 a genuine gear combination 100, comprised of a central gear block 101 as well as the two upstream gears 40 and 45 with the assigned drive motors 22 and 18. In FIG. 7, the electromotive drive of the axle A1 is developed as hollow motor 39. This permits the largest possible structural concentration for the rotative drive.

FIGS. 8a and 8b show the central gear block 101 in a larger scale, having a gear casing 102. Approximately in the reference axis 103 of the gear casing 102 is the drive axle 104, which has on the output side a coupling piece 20 and on the opposite side a splined shaft 56. The splined shaft 56 is driven by a splined hub 55, which is connected to the drive motor 18 through the gearing 40 and a coupling 105. The drive motor 18 is connected to a machine control through a power- and control line. The box 107 is securely screwed to the gear casing 102. Unlike the FIGS. 4 as well as 5a and 5b, with the solution according to FIGS. 8a and 8b, the entire splined shaft moves in axial direction within the splined hub. The axial displacement path of the drive axle 104 is labeled Axv. The axial movement of the injection screw is ensured by the following elements: Two double rack rails 110 and 110′ each are rigidly connected on a rack rail transverse beam 111. Said transverse beam is axially developed as a compact displacement unit, and is connected to a bearing bushing 112 and supported on the drive axle 104 by the roller bearings 57 and 58. Inside the bearing bushing 112, the drive axle 104 has an enlarged diameter “D”, so that the axial forces are transmitted and/or captured by the two shoulders 113 and 114 and the bearings 57, 58. Two each pinion gears 115 and 116, respectively 117 and 118, are assigned to the double rack rails 110, 110′, with the pinion gear 116 being driven directly by the motor drive and the three others by the overdrive gears 119, 120, 121, 122. Because all overdrive gears 119, 120, 121 and 122 mesh together, as is shown in FIG. 9b [sic], a reverse movement is created for the gear pairs assigned to the rack rail 110 as well as to the rack rail 110′. The same applies to the two pinion pairs 115/116 resp. 117/118, which are opposite one each rack rail 110 resp. 110′. The lateral forces created at the helical gears are thus compensated, as is the momentum resulting from the two rack rails.

Each single pinion gear 115, 116, 117 and 118 can be adjusted with respect to its respective axis of rotation “XZ” according to FIGS. 9 and 10, as is indicated by the arrow 123, for a precise adjustment of each gear meshing. The axis of rotation “XZ⇄ is held in its upper portion through a sliding bearing 124 and on the bottom by two oppositely directed roller bearings 125, 125′ in an adjustment bushing 126. The adjustment bushing 126 can be adjusted by means of a supporting thread 127 relative to the gear casing 102 by a corresponding rotation movement, according to arrow 123. In this way, the location of the gear meshing can be precisely adjusted. As is shown in FIG. 9, the drive motors can also be integrated in the respective other direction (top/bottom).

1. Drive of the injection screw (4) of an injection molding machine having at least one electrical motor (A1, A2) for the rotative and for the axial movement of the injection screw (4),
characterized in that
it has a rack rail overdrive with at least one double rack rail for the axial movement of the injection screw (4), and the rotative and the axial movement can be combined in one drive unit (100).

2. Drive of the injection screw (4) in accordance with claim 1,
characterized in that
the overdrive has two double rack rails (110, 110′).

3. Drive of the injection screw in accordance with claim 2,
characterized in that
the double rack rails (110, 110′) are arranged on both sides in a distance and parallel to the axis of rotation of the injection screw (4).

4. Drive of the injection screw (4) in accordance with one of the claims 1 to 3,
characterized in that
the rack rail overdrive (71) is developed as helical gearing.

5. Drive of the injection screw (4) in accordance with claim 4,
characterized in that
the helical gearings of both sides are each opposite a double rack rail (65, 65′, 85) to balance the forces from the helical gearing.

6. Drive of the injection screw (4) in accordance with claim 4 or 5,
characterized in that
the helical gearing of each of the two double rack rails (110, 110′) is developed diametrically opposed to balance the momentum from the helical gearing of the two double rack rails (110, 110′).

7. Drive of the injection screw (4) in accordance with one of the claims 4 to 6;
characterized in that
the gear-tooth profile of the double rack rails (110, 110′) and the pinion gears (115-118) are arranged on a common plane and the pinion gears (115-118) can be adjusted for a complete balancing of the forces in the direction of their axes of rotation (27).

8. Drive of the injection screw (4) in accordance with claim 1,
characterized in that
the gearing for the rotative movement and the gearing for the axial movement are integrated in a common assembly (FIG. 4).

9. Drive of the injection screw (4) in accordance with one of the claims 1 to 8,
characterized in that
the rotation- and displacement mechanism is designed as a compact assembly and is guided in a guide tube that is aligned coaxially to the axis of the injection screw (41) (FIG. 4).

10. Drive of the injection screw (4) in accordance with claim 8,
characterized in that
the drive unit has a compact assembly guided in a guide tube that is aligned coaxially to the axis of the injection screw (41) and the rack rails (65, 65′) are supported on the output side through a secure connection with the bearing bushing (59, 112) of the screw coupling part.

11. Drive of the injection screw (4) in accordance with claim 9,
characterized in that
the screw coupling part has two axial radial bearings (57, 58) and the bearing bushing (59) is displaceably guided through a guide tube.

12. Drive of the injection screw (4) in accordance with one of the claims 9 to 11,
characterized in that
the rack rails (65, 65′) are guided with a guide band (74) into the guide tube at the end side facing away from the injection screw (4) through a blind flange.

13. Drive of the injection screw (4) in accordance with one of the claims 9 to 12,
characterized in that
the rack rail overdrive has two rack rails, each in distance and parallel to the axis of rotation of the injection screw (4) and preferably with the gear-tooth profile directed outward in such a way that the common line of action of the gear drive forms an extension of the axis of rotation of the injection screw (4).

14. Drive of the injection screw in accordance with one of the claims 9 to 13,
characterized in that
the rack rails can be driven by a drive motor (A2) with a gearing (45) with two outputs or by two drive motors (A2.1, A 2.2), and the drive motors are attached with their axles perpendicularly projecting upward relative to the injection screw drive.

15. Drive of the injection screw (4) in accordance with claim 1,
characterized in that
the rotative drive is effected through a splined hub (55) and a splined shaft (56) as “sliding bearing”, which is connected to a drive motor.

16. Drive of the injection screw (4) in accordance with claim 15,
characterized in that
the splined shaft (56) is mounted on the drive side in a gearing (40, 80) and guided in the splined hub (55) for the required stroke length, and that it is connected to the screw coupling by a sleeve (54) to transmit the moment of torsion.

17. Drive of the injection screw (4) in accordance with one of the claims 15 or 16,
characterized in that
the splined hub (55) and the sleeve (54) run in the back position essentially across the length of the rack rails (65, 65′), with the splined shaft (56) aligned to the axis of the screw shaft and the sleeve (54) and the rack rails (65, 65′) being arranged coaxially and/or symmetrically thereto.

18. Drive of the injection screw (4) in accordance with one of the claims 1 to 8,
characterized in that
the rack rails (85, 110, 110′) are developed on a quarter profile with two-sided gearing.

19. Drive of the injection screw (4) in accordance with claim 1 or 18,
characterized in that
it has at least one rack rail overdrive (83-86) for the axial movement of the injection screw (4) and is developed as double axle gearing, with the axis of action of the rack rail (85) coinciding with the axis of rotation for the rotative movement of the injection screw (4) in the sense of a continuation.

20. Drive of the injection screw (4) in accordance with claim 19,
characterized in that
the gearing (80) for the rotative movement and the gearing (81) for the axial movement of the injection screw (4) each have independent gear housings (82) (FIG. 7a) [sic].

21. Drive of the injection screw (4) in accordance with one of the claims 18 to 20,
characterized in that
a slide bearing with splined hub (55) and splined shaft (56) is arranged in the gearing (80) for the rotative movement of the injection screw.

22. Drive of the injection screw (4) in accordance with one of the claims 1 to 18,
characterized in that
the electrical motor (A1) for the rotative movement of the injection screw (4) is developed as an asynchronous servo motor.

23. Drive of the injection screw (4) in accordance with one of the claims 1 to 18,
characterized in that
the electrical motor (A1) for the rotative movement of the injection screw (4) is developed as a hollow motor (39).

24. Drive of the injection screw (4) in accordance with one of the claims 1 to 25,
characterized in that
the electrical motor (A2) for the axial movement of the injection screw (4) is developed as an AC-synchronous servo motor with performance electronics and assigned computer- as well as controlling means.
